(19) United States
(12) Patent Application Publication
(10) Pub. No.: US 2003/0074488 A1
(43) Pub. Date: Apr. 17, 2003

(54) Method and apparatus for communicating between modules

(76) Inventors: David A. Griego, Chandler, AZ (US); Dave Jiang, Chandler, AZ (US); Dan Krejsa, Alameda, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/981,973

(22) Filed: Oct. 17, 2001

(51) Int. Cl. G06F 3/00

(52) U.S. Cl. 710/1

(57) ABSTRACT

A method and apparatus comprising establishing a direct call interface for modules to communicate that includes an initial communication between modules using messages. The messages include the functions supported by the modules along with pointers to the functions. Subsequent communications between modules use the pointers to the functions to communicate.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND OF THE INVENTION

1. Field of the Invention

The present invention is related to the field of electronics. In particular, the present invention is related to a method and apparatus for communicating between modules.

2. Description of the Related Art

In computer systems there exists a need for processing large amounts of data in the shortest possible time. One method to satisfy this need is through the use of a bus (e.g., a peripheral component interconnect (PCI) bus) using intelligent input/output architecture. FIG. 1 illustrates an example of the intelligent input/output architecture 100 using a PCI bus. The intelligent input/output architecture processes large amounts of data in the shortest possible time by offloading low-level interrupts from a host processor to an I/O (input/output) processor that resides on a separate bus (e.g., the PCI bus).

As illustrated in FIG. 1, a host machine 101 comprising of at least a host processor 105 is communicatively coupled with memory 115 (e.g., synchronous dynamic random access memory (SDRAM)) via host bus 110. Host machine 101 is communicatively coupled with an P/O processor 125 via PCI bus 120. I/O processor 125 is communicatively coupled with I/O processor local memory 135 via local memory bus 130. In addition, I/O processor 125 is communicatively coupled with operating system module 140 (e.g., an intelligent real time operating system (IRTOS)). Operating system module 140 provides a platform for communications between 10 processor 125 and modules such as device drivers. A device driver may be a hardware device module (HDM) 150 which may reside on and interface with an adapter (e.g., a network adapter), or an intermediate service module (ISM) that provides special functionality such as building a transport control protocol/internet protocol (TCP/IP) (see request for comment (RFC) 793 and RFC 879) message, or performing some special function e.g., calculating the checksum of all packets arriving to and from I/O processor 125. The I/O processor along with the IRTOS and the associated modules comprise an I/O system 172 that handles at least all the I/O operations for the host system.

In order to provide flexibility and support for every combination of I/O device and operating system available, host machine 101 operating system module 140, hardware device module 150, and the intermediate service module 145 communicate with each other using messages. Communicating via the use of messages provides a layer of abstraction and flexibility as the modules communicate with each other without knowledge of the underlying bus architecture or of the system topology. However, the use of messages to communicate is inefficient and slow, as each message requires constructing the message with its appropriate header and payload.

### BRIEF SUMMARY OF THE DRAWINGS

Examples of the present invention are illustrated in the accompanying drawings. The accompanying drawings, however, do not limit the scope of the present invention. Similar references in the drawings indicate similar elements.

FIG. 1 illustrates an example of a prior art intelligent input/output architecture;

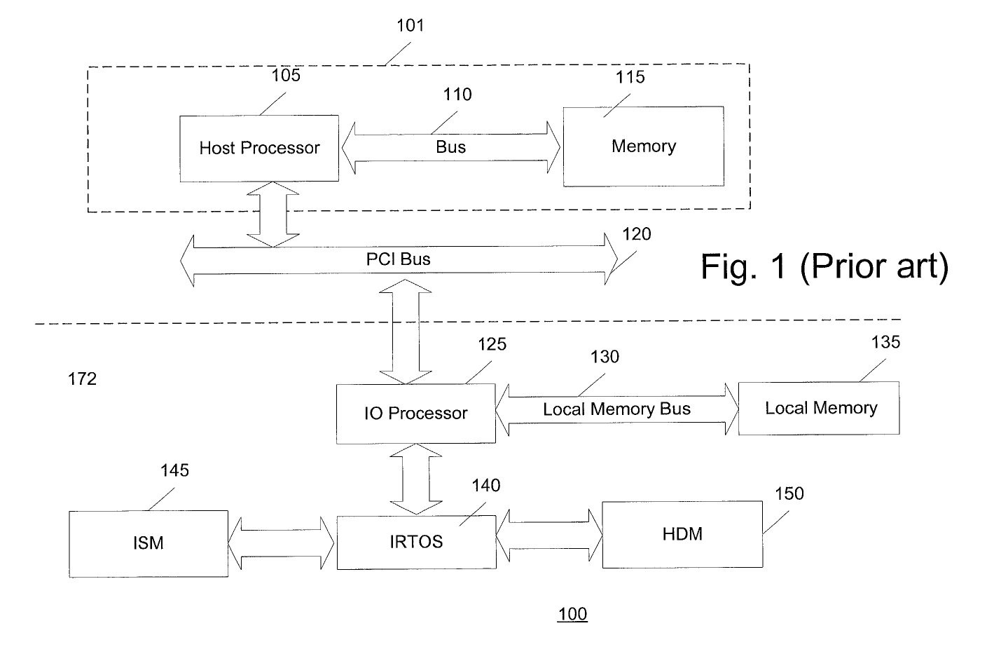

FIG. 2 illustrates a flow diagram for communicating using messages in a prior art embodiment;

FIG. 3 illustrates a flow diagram for establishing a direct call interface according to one embodiment of the invention;

FIG. 4 illustrates a flow diagram for communicating after establishing the direct call interface according to one embodiment of the invention;

FIG. 5 is a block diagram of a computer system according to one embodiment of the invention;

FIG. 6 is a block diagram of a machine accessible medium according to one embodiment of the invention.

### DETAILED DESCRIPTION OF THE INVENTION

Described is a method and apparatus for communicating using messages and function pointers. In the following description, numerous specific details are set forth in order to provide a thorough understanding of the present invention. It will be apparent, however, to one of ordinary skill in the art that the present invention may be practiced without these specific details. In other instances, well-known architectures, steps, and techniques have not been shown to avoid unnecessarily obscuring the present invention. For example, specific details are not provided as to whether the method is implemented in a router, switch, modem, as a software routine, hardware circuit, firmware, or a combination thereof.

Parts of the description will be presented using terminology commonly employed by those skilled in the art to convey the substance of their work to others skilled in the art. Also, parts of the description will be presented in terms of operations performed through the execution of programming instructions. As well understood by those skilled in the art, these operations often take the form of electrical, magnetic, or optical signals capable of being stored, transferred, combined, and otherwise manipulated through, for instance, electrical components.

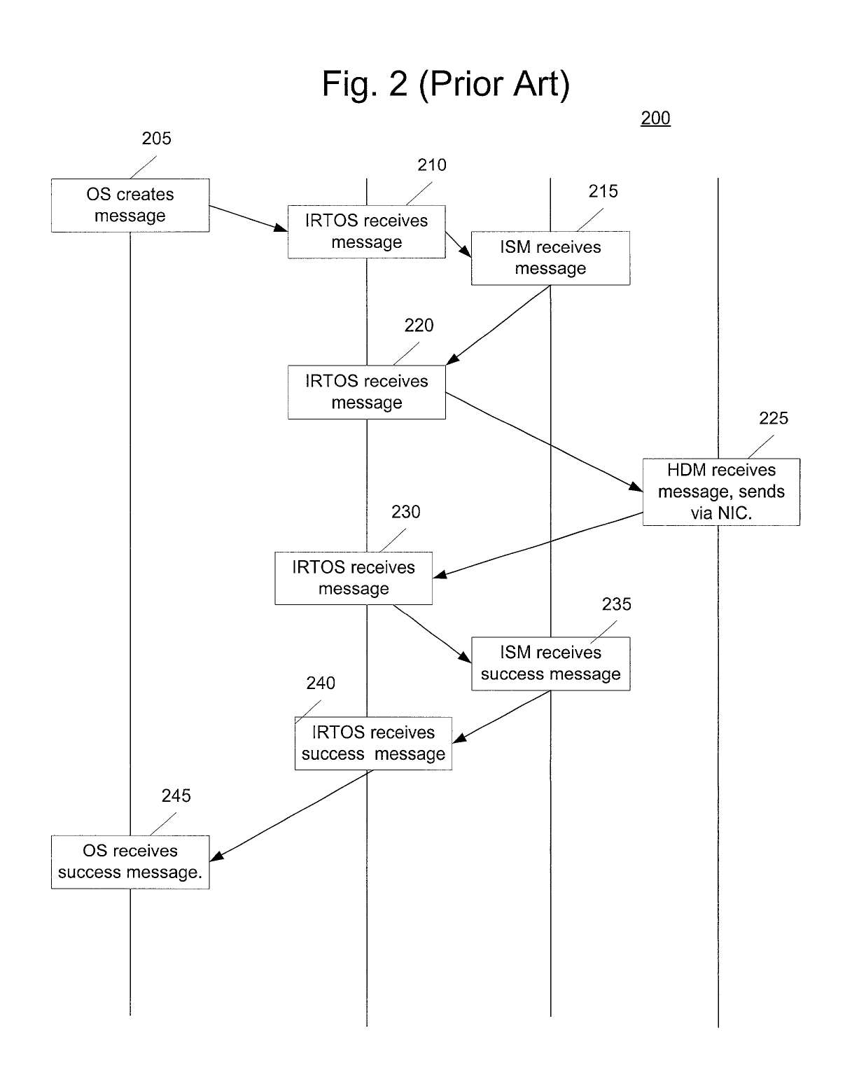

FIG. 2 illustrates a flow diagram for communicating using messages in a prior art embodiment. As illustrated in flow diagram 200 of FIG. 2, at 205 a host (e.g., a host computer) decides to send a message across a network (e.g., a local area network (LAN), a wide area network (WAN), or the Internet). An operating system module on the host computer creates the message (e.g., by constructing the header with at least addressing information, and the payload with the text of the message) and transmits the message to an operating system module (e.g., a IRTOS) that is communicatively coupled with an I/O processor across a bus (e.g., a PCI bus). On receiving the message at 210, the IRTOS determines that the message is to be delivered to a network and sends the message to the intermediate service module (ISM) to encapsulate the message in a network header (e.g., a TCP/IP header). At 215, the ISM receives the message and encapsulates the message in a TCP/IP header. After encapsulating the message in a TCP/IP header the ISM sends the message back to the IRTOS. At 220 the IRTOS receives the message and determines that the message is to be delivered to the hardware device module (HDM) that interfaces with a network interface card (NIC), and sends the message to the HDM. At 225, the HDM receives the message and sends the message toward its destination on the network via the NIC.

Once the message is sent by the NIC, the HDM sends a message (indicating the successful transmission of the message by the NIC) to the originator of the message (i.e., the host computer). In order for the host to receive the successful transmission message, the message is sent by the HDM to the IRTOS. At 230, the IRTOS receives the successful transmission message and determines that the successful transmission message is to be delivered to the host computer and sends the successful transmission message to the ISM. At 235, the ISM receives the successful transmission message and encapsulates the message with appropriate header information and sends the successful transmission message to the IRTOS. At 240, the IRTOS receives the successful transmission message and determines that the message is to be delivered to the operating system on the host computer and sends the message to the operating system on the host computer. At 245, the operating system on the host computer receives the successful transmission message. The process described above is followed for each message sent by the host computer to a network destination. Since a significant amount of system resources are utilized in building, sending, and receiving messages, the use of messages to communicate is inefficient and slow.

The invention described herein may utilize a distributed computing environment. In a distributed computing environment, program modules may be physically located in different local and remote memory storage devices. Execution of the program modules may occur locally in a stand-alone manner or remotely in a client/server manner. Examples of such distributed computing environments include local area networks, enterprise-wide computer networks, and the Internet.

Various operations will be described as multiple discrete steps performed in turn in a manner that is helpful in understanding the present invention. However, the order of description should not be construed to imply that these operations are necessarily performed in the order they are presented, or even order dependent. Lastly, repeated usage of the phrase “in one embodiment” does not necessarily refer to the same embodiment, although it may.

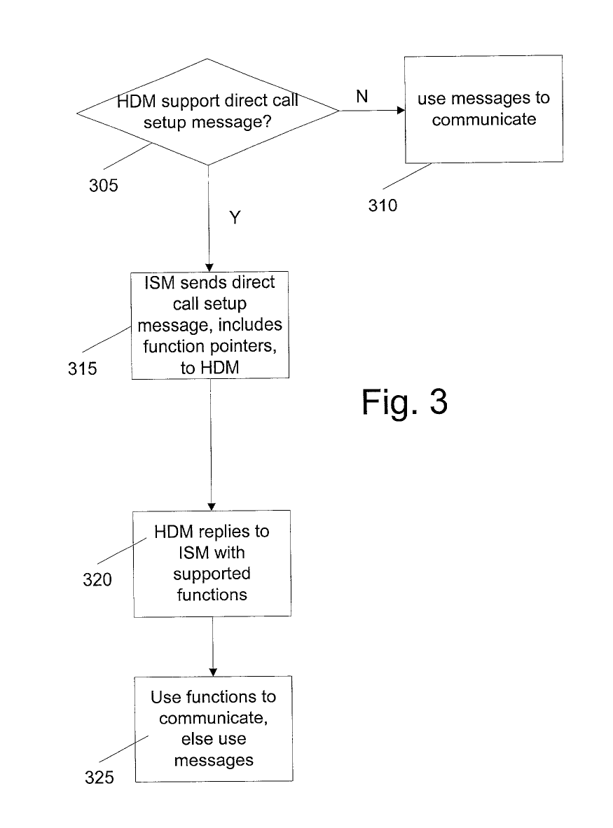

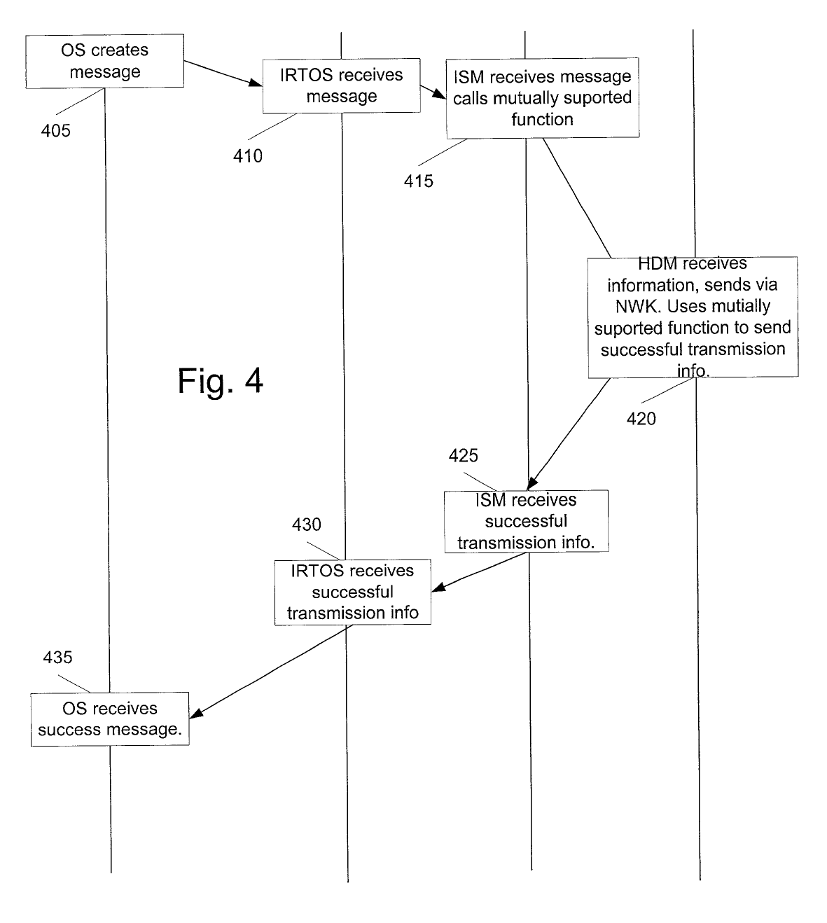

In order to maintain the flexibility afforded by a message system (i.e., by modules communicating with each other without the knowledge of the underlying bus architecture) and simultaneously to speed up communications, FIG. 3 and FIG. 4 illustrate a process for setting up and using a direct call interface that includes an initial communication between modules using messages, but subsequent communications using pointers to functions.

FIG. 3 illustrates a flow diagram for establishing a direct call interface according to one embodiment of the invention. Although the description that follows uses a HDM and an ISM, one skilled in the art will appreciate that the method and apparatus described herein may be used for communication between any modules that reside on a bus and that do not share an address space with a host system. Thus, the method and apparatus may be used for modules that reside on a PCI bus, an extended industry standard architecture (EISA) bus, a universal serial bus (USB), a PCIX bus, a 3GIO bus, a hyper-transport bus, an infiniband architecture, etc., and whose address space may be separate from the address space of the host system (e.g., a host computer system).

As illustrated in FIG. 3, at 305, an ISM sends a message to a HDM to determine whether the HDM supports direct call interface wherein functions are called directly by modules to facilitate communication in lieu of communicating using messages. If, at 310, the HDM replies with a message indicating that the HDM does not support the direct call interface, communications between the HDM and the ISM occur using messages.

However, if the HDM supports direct call interface, at 315, the ISM sends a message to the HDM indicating the capabilities of the ISM. In one embodiment, the capabilities of the ISM include functions supported by the ISM, along with corresponding pointers to the functions supported by the ISM. One skilled in the art will appreciate that a pointer to a function includes the memory location at which the function resides, and is the memory location from which a processor executes the instructions comprising the function. Although the embodiment describes pointers to functions being passed by modules (e.g., the HDM and the ISM), one skilled in the art will appreciate that pointers to sub-routines, or pointers to programming code may alternately be passed by the modules.

In one embodiment, the functions supported by the ISM along with the corresponding pointers to the functions are sent by the ISM at 305, i.e., along with the message sent by the ISM to the HDM to determine whether the HDM supports the direct call interface.

At 320, the HDM responds to the ISM with a message indicating the capabilities of the HDM. The capabilities of the HDM include functions supported by the HDM along with corresponding pointers to the functions supported by the HDM. At 325, the HDM is aware of the capabilities of the ISM, and the ISM is aware of the capabilities of the HDM, thus establishing the direct call interface. Moreover, both the HDM and the ISM have access to pointers to functions that the other module supports (i.e., both the HDM and the ISM have access to functions that the other module is capable of executing). Having access to the pointers to the functions supported by the HDM, allows the ISM to communicate with the HDM using the supported functions without the use of messages. So also, the HDM may communicate with the ISM via the use of the functions supported by the ISM without the use of messages.

In one embodiment, the process to determine the capabilities of the various modules is performed during startup or boot-up of the host computer system. In alternate embodiments, the process to determine the capability of the various modules is performed on an as needed basis e.g., prior to the modules in the I/O system communicating with each other. However, once the capabilities of the modules in the I/O system are determined the modules may thereafter communicate using pointers to the functions supported by the modules without the need to determine the capabilities of the modules for each communication. In one embodiment, the capabilities of the modules in the I/O system are stored in a database wherein the data is input into the database dynamically (e.g., whenever the IRTOS detects a module). The database containing the functions along with the corresponding pointers to the functions is accessible by all modules in the I/O system.

FIG. 4 illustrates a flow diagram for communicating after establishing the direct call interface according to one embodiment of the invention. As illustrated in FIG. 4, at 405 a host (e.g., a host computer) decides to send information across a network (e.g., a local area network (LAN), a wide area network (WAN), or the Internet). An operating system on the host creates the message (e.g., by constructing the header with at least addressing information, and the payload with the text of the message) and transmits the message to an operating system module (e.g., a IRTOS) that is communicatively coupled with an I/O processor across a bus (e.g., a PCI bus). At 410, the IRTOS receives the message and determines that the message is to be delivered to a network and sends the message to the ISM. The ISM, at 415, obtains the information from the message and calls a function (e.g., a transmit function) using the function pointer obtained during the set-up of the direct call interface to transmit the information obtained from the message to the HDM. At 420, the HDM receives the information and sends the information toward its network destination via the NIC. After sending the information, received from the ISM, the HDM calls a function using the function pointer obtained during the set-up of the direct call interface to send a message (i.e., a successful transmission message) to the ISM that the information was successfully sent via the NIC. At 425, the ISM receives the message via the function call and sends the message to the IRTOS indicating that the information was sent successfully. At 430, the IRTOS receives the successful transmission message from the ISM and sends the message to the operating system on the host computer. The operating system on the host computer informs the user that the message was successfully sent.

The method described allows for dynamic direct call interface negotiation between modules. Modules may be added or removed from the I/O system dynamically, and the I/O system is made aware of the capabilities of each module in the system. Thus, once the direct call interface is set up, modules may communicate using functions instead of messages thereby realizing a substantial increase in performance, while retaining the flexibility afforded by the messaging concept, i.e., modules may communicate without knowledge of the underlying bus architecture or system topology.

In one embodiment, pointers to functions are used to implement functions that affect I/O system performance. In alternate embodiments, functions and associated pointers are used to implement all I/O functions.

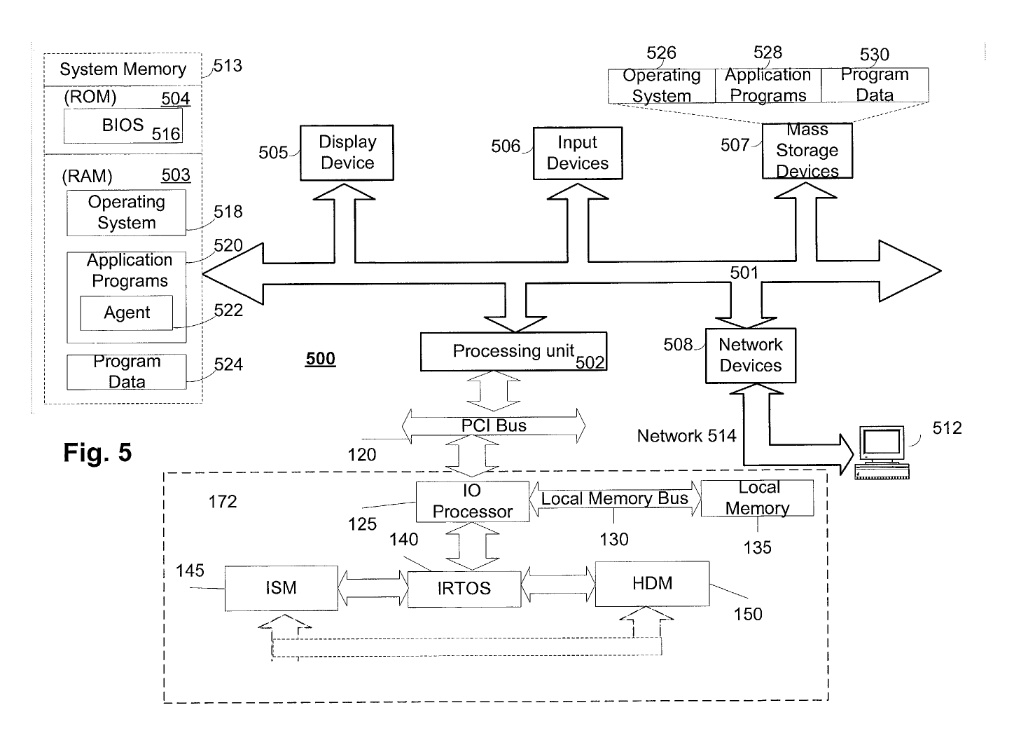

FIG. 5 illustrates a typical computer system in which the present invention operates. One embodiment of the present invention is implemented using personal computer (PC) architecture. It will be apparent to those of ordinary skill in the art that alternative computer system architectures or other processor, programmable or electronic-based devices may also be employed.

In general, the computer system 500 (i.e., a host machine) illustrated by FIG. 5 includes a processing unit 502 coupled through a bus 501 to a system memory 513. System memory 513 comprises a read only memory (ROM) 504, and a random access memory (RAM) 503. ROM 504 comprises Basic Input Output System (BIOS) 516, and RAM 503 comprises operating system 518. Application programs 520, agent 522, and program data 524.

In one embodiment, Agent 522 comprises the executable program that establishes the direct call interface between modules in I/O system 172, and facilitate communication between modules in I/O system 172 using the direct call interface. In particular, agent 522 includes program instructions to dynamically build a direct call interface. In alternate embodiments, the executable program that establishes the direct call interface between modules in I/O system 172, and facilitates communication between modules in I/O system 172 using the direct call interface may be stored in local memory 135. In order to dynamically build the direct call interface, a sending module (e.g., ISM 145) sends a message to a receiving module (e.g., HDM 150), the message comprises one or more functions supported by a sending module (e.g., ISM 145) along with the corresponding function pointers to the functions supported by the sending module. Agent 522 includes program instructions for the ISM to receive from the HDM a message that includes one or more functions supported by the HDM along with corresponding function pointers to the functions supported by the HDM. Thus, the direct call interface is established and the sending and receiving modules are aware of each other's capabilities. In particular, each module is aware of the functions supported by the other module, and has access to pointers to the functions that the other modules support. In one embodiment, the direct call interface including the functions and corresponding pointers to the functions are stored in local memory 135. After establishing the direct call interface, the sending and receiving modules communicate with each other using the function pointers to the functions supported by the other module.

Computer system 500 includes mass storage device 507, Input devices 506 and display device 505 coupled to processing unit 502 via bus 501. Mass storage device 507 represents a persistent data storage device, such as a floppy disk drive, fixed disk drive (e.g., magnetic, optical, magneto-optical, or the like), or streaming tape drive. Mass storage device stores Program data 530, application programs 528, and operating system 526. Application programs 528 may include agent software 522. Processing unit 502 may be any of a wide variety of general purpose processors or microprocessors (such as the Pentium® processor manufactured by Intel® Corporation), a special purpose processor, or even a specifically programmed logic device.

In one embodiment, the processing unit 502 is operable to receive instructions which, when executed by the processing unit, causes the processing unit to execute the instructions of agent 522.

Display device 505 provides graphical output for computer system 500. Input devices 506 such as a keyboard or mouse are coupled to bus 501 for communicating information and command selections to processor 502. Also coupled to processor 502 through bus 501 are one or more network devices 508 (e.g., a network interface card) that can be used to control and transfer data to electronic devices (printers, other computers, etc.) connected to computer 500. Network devices 508 also connect computer system 500 to a network, 514, and may include Ethernet devices, phone jacks and satellite links, for example, to connect computer system 500 to remote computer 512. It will be apparent to one of ordinary skill in the art that other network devices may also be utilized.

In one embodiment, processing unit 502 is communicatively coupled to I/O processor 125, via a bus 120 (e.g., a PCI bus). I/O processor 125 is communicatively coupled with I/O processor local memory 135 via local memory bus 130. In addition, I/O processor 125 is communicatively coupled with operating system module 140 (e.g., an intelligent real time operating system (IRTOS)). Operating system module 140 provides a platform for communications between 10 processor 125 and modules such as device drivers. A device driver may be a hardware device module (HDM) 150 which may reside on and interface with an adapter (e.g., a network adapter), or an intermediate service module (ISM), 145, that provides special functionality such as building a TCP/IP message, or performing some special function e.g. calculating the checksum of all packets arriving to and from I/O processor 125. The I/O processor along with the IRTOS and the associated modules comprise an I/O system 172 that handles at least all the I/O operations between the host system and a network.

One embodiment of the invention may be stored entirely as a software product on mass storage 507. Another embodiment of the invention may be embedded in a hardware product (not shown), for example, in a printed circuit board, in a special purpose processor, or in a specifically programmed logic device communicatively coupled to bus 501. Still other embodiments of the invention may be implemented partially as a software product and partially as a hardware product.

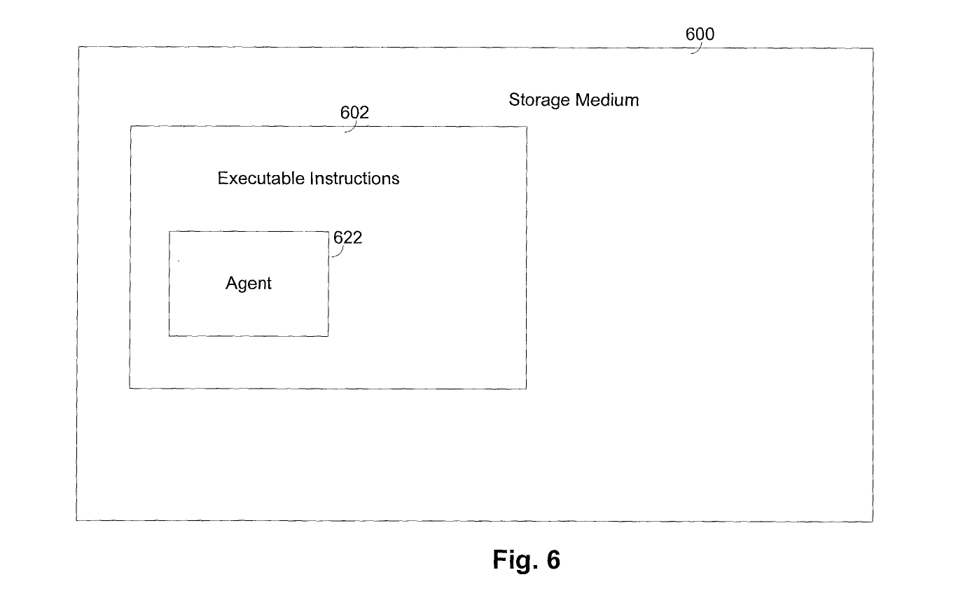

FIG. 6 is a block diagram of a machine accessible medium according to one embodiment of the invention. Embodiments of the invention may be represented as a software product stored on a machine-accessible medium 600 (also referred to as a computer-accessible medium or a processor-accessible medium). The machine-accessible medium 600 may be any type of magnetic, optical, or electrical storage medium including a diskette, CD-ROM, memory device (volatile or non-volatile), or similar storage mechanism. The machine-accessible medium may contain various sets of instructions 602, code sequences, configuration information, or other data. Those of ordinary skill in the art will appreciate that other instructions and operations necessary to implement the described invention may also be stored on the machine-accessible medium.

The machine-accessible medium comprises instructions, incorporated in agent 622, that when executed by a machine causes the machine to perform operations comprising establishing the direct call interface between modules in an I/O system, and facilitating communication between modules in the I/O system using the direct call interface. In particular, agent 622 includes program instructions to dynamically build a direct call interface. In order to dynamically build the direct call interface, a sending module (e.g., an ISM) sends a message to a receiving module (e.g., a HDM), the message comprises one or more functions supported by a sending module along with the corresponding function pointers to the functions supported by the sending module. Agent 622 includes program instructions for the ISM to receive from the HDM a message that includes one or more functions supported by the HDM along with corresponding function pointers to the functions supported by the HDM. Thus, the direct call interface is established and the sending and receiving modules are aware of each other's capabilities. In particular, each module is aware of the functions supported by the other module, and has access to pointers to the functions that the other module supports. After establishing the direct call interface, the sending and receiving modules communicate with each other using the function pointers to the functions supported by the other module.

Thus, a method and apparatus have been disclosed for establishing a direct call interface between modules using messages, and for modules to communicate with each other using pointers to the functions established by the direct call interface. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method comprising:
sending a message to a receiving module, the message comprising at least one function supported by a sending module along with at least one corresponding function pointer to the at least one function supported by the sending module;
receiving from the receiving module a message including at least one function supported by the receiving module along with at least one corresponding function pointer to the at least one function supported by the receiving module; and
communicating with the receiving module using the at least one function pointer to the at least one function supported by the receiving module.

2. The method of claim 1 further comprising:
determining functions that are called directly, by the sending module and the receiving module; and
building an interface using the functions that are called directly, by the sending module and the receiving module.

3. The method of claim 1 further comprising communicating with the receiving module using messages if the receiving module does not support a particular function.

4. The method of claim 1 wherein the sending module and the receiving module are locally disposed on a bus.

5. The method of claim 4 wherein the bus is at least one of a peripheral component interconnect (PCI) bus, an EISA bus, a PCIX bus, a 3GIO bus, a hyper-transport bus, and an infiniband architecture.

6. The method of claim 1 wherein the receiving module communicates with at least one of a controller, and a storage device.

7. The method of claim 6 wherein the controller is a network controller.

8. The method of claim 1 wherein the sending module and the receiving module communicate with each other via a first processor.

9. The method of claim 8 wherein the first processor communicates with a second processor via a bus.

10. A method comprising:
receiving a message from a sending module, the message comprising of at least one function supported by a sending module along with at least one corresponding function pointer to the at least one function supported by the sending module;
sending the sending module a message including at least one function supported by a receiving module along with at least one corresponding function pointer to the at least one function supported by the receiving module; and
communicating with the sending module using the function pointer to the at least one function supported by the receiving module.

11. The method of claim 10 further comprising:
determining functions are called directly, by the sending module and the receiving module; and
building an interface using the functions that can be called directly, by the sending module and the receiving module.

12. The method of claim 10 further comprising communicating with the sending module using messages if the receiving module does not support a particular function.

13. An apparatus comprising:
a bus;
a processor communicatively coupled with the bus, said processor to
send a message to a receiving module, the message comprising at least one function supported by a sending module along with at least one corresponding function pointer to the at least one function supported by the sending module;
receive from the receiving module a message including at least one function supported by the receiving module along with at least one corresponding function pointer to the at least one function supported by the receiving module; and
communicate with the receiving module using the function pointer to the at least one function supported by the receiving module.

14. The apparatus of claim 13 further comprising said processor to
determine functions that are called directly, by the sending module and the receiving module; and
build an interface using the functions that are called directly, by the sending module and the receiving module.

15. The apparatus of claim 13 further comprising said processor to communicate with the receiving module using messages if the receiving module does not support a particular function.

16. The apparatus of claim 13 wherein the sending module and the receiving module are locally disposed on a bus.

17. The apparatus of claim 13 wherein the receiving module communicates with at least one of a controller, and a storage device.

18. The apparatus of claim 17 wherein the controller is a network controller.

19. The apparatus of claim 13 wherein the processor communicates with a second processor via a bus.

20. An article of manufacture comprising:
a machine-accessible medium including instructions that, when executed by a machine, causes the machine to perform operations comprising
sending a message to a receiving module, the message comprising at least one function supported by a sending module along with at least one corresponding function pointer to the at least one function supported by the sending module;
receiving from the receiving module a message including at least one function supported by the receiving module along with at least one corresponding function pointer to the at least one function supported by the receiving module; and communicating with the receiving module using the at least one function pointer to the at least one function supported by the receiving module.

21. The article of manufacture as in claim 20, further comprising instructions for
determining functions that can be called directly, by the sending module and the receiving module; and
building an interface using the functions that can be called directly, by the sending module and the receiving module.

22. The article of manufacture as in claim 20, further comprising instructions for communicating with the receiving module using messages if the receiving module does not support a particular function.

23. The article of manufacture as in claim 20, wherein said instructions for communicating with the receiving module using the at least one function pointer to the at least one function supported by the receiving module includes further instructions for communicating with at least one of a controller, and a storage device.

24. An article of manufacture comprising:
a machine-accessible medium including instructions that, when executed by a machine, causes the machine to perform operations comprising
receiving a message from a sending module, the message comprising at least one function supported by a sending module along with a corresponding function pointer to the at least one function supported by the sending module;
sending to the sending module a message including at least one function supported by the receiving module along with a corresponding function pointers to the at least one function supported by the receiving module; and communicating with the sending module using the function pointer to the at least one function supported by the receiving module.

25. The article of manufacture as in claim 24, further comprising instructions for
determining functions that can be called directly, by the sending module and the receiving module; and
building an interface using the functions that can be called directly, by the s sending module and the receiving module.

26. The article of manufacture as in claim 24, further comprising instructions for communicating with the sending module using messages if the receiving module does not support a particular function.
